(19) United States
(12) Patent Application Publication
(10) Pub. No.: US 2022/0036351 A1
(43) Pub. Date: Feb. 3, 2022

(54) METHOD AND APPARATUS FOR RESOURCE EXCHANGE

(71) Applicant: ALIPAY (HANGZHOU) INFORMATION TECHNOLOGY CO., LTD., Hangzhou (CN)

(72) Inventor: Jiankang SUN, HANGZHOU (CN)

(21) Appl. No.: 17/359,593

(22) Filed: Jun. 27, 2021

(30) Foreign Application Priority Data
Jul. 31, 2020 (CN) 202010759190.0

(51) Int. Cl. G06Q 20/38; G06Q 20/36; G06Q 20/10; G06Q 20/40; G06Q 20/08

(52) U.S. Cl. CPC G06Q 20/38215; G06Q 20/3674; G06Q 20/0855; G06Q 20/401; G06Q 20/102

(57) ABSTRACT

A method includes: in response to a resource transfer operation initiated by a user on a transaction client of a user terminal to transfer a resource, generating a resource transfer request, wherein the resource transfer request includes resource transfer information that includes an certificate identifier; sending, through a transaction server corresponding to the transaction client, the resource transfer request to a resource transfer server coupled with the transaction server, causing the resource transfer server to: obtain a resource transfer certificate from a blockchain according to the certificate identifier; and generate and return a resource transfer identifier for the resource transfer information to the transaction client through the transaction server; and based on the resource transfer identifier, initiating a resource transfer confirmation to the resource transfer server, causing the resource transfer server to complete resource transfer processing based on the resource transfer information corresponding to the resource transfer identifier.

### CROSS REFERENCE TO RELATED APPLICATIONS

This application claims priority to and benefits of Chinese Patent Application No. 202010759190.0 filed on Jul. 31, 2021. The content of the above-referenced application is incorporated herein by reference in its entirety.

### TECHNICAL FIELD

One or more embodiments of the present specification relate to the field of network communication, and in particular, to a resource transfer method and a resource transfer apparatus.

### BACKGROUND

When a user makes a remittance transfer, a user account opened with a bank or other financial institutions or a user account opened with a payment institution associated with a bank is often used for remittance transfer between accounts. At present, remittance transfers cannot be performed directly based on a user account opened by the user in a financial institution or a payment institution associated with the financial institution in a transaction application client.

### SUMMARY

In view of this, one or more implementations of the present specification provide a resource transfer method, which may be applicable to a user's transaction client. The method includes: in response to a resource transfer operation initiated by a user on the transaction client of a user terminal to transfer a resource, generating a resource transfer request, wherein the resource transfer request includes resource transfer information that includes an certificate identifier;

sending, through a transaction server corresponding to the transaction client, the resource transfer request to a resource transfer server coupled with the transaction server, causing the resource transfer server to obtain a resource transfer certificate from a blockchain according to the certificate identifier, wherein the resource transfer server is a node device of the blockchain; perform authenticity verification on the resource transfer certificate; in response to successful authenticity verification on the resource transfer certificate, generate a resource transfer identifier for the resource transfer information, and return the resource transfer identifier to the transaction client through the transaction server; and

based on the resource transfer identifier, initiating a resource transfer confirmation to the resource transfer server, causing the resource transfer server to complete resource transfer processing based on the resource transfer information corresponding to the resource transfer identifier.

In some embodiments, the resource transfer information includes: a quantity of resources to be transferred, account information of a resource transfer account established by the user on the resource transfer server, and account information of a recipient account for receiving resource transfer.

In some embodiments, the resource transfer information further includes certification information related to the resource transfer from the resource transfer account to the recipient account.

The resource transfer identifier corresponds to the resource transfer information and is generated after the resource transfer request is authenticated by the resource transfer server based on the certification information.

In some embodiments, the resource transfer server includes a node device of a blockchain, and the certification information includes a certificate identifier of the original information of the resource transfer certificate stored on the blockchain. The resource transfer server performing authenticity verification on the resource transfer request based on the certification information includes: obtaining the original information of the resource transfer certificate from the blockchain based on the certificate identifier, and performing authenticity verification based on the original information of the resource transfer certificate.

In some embodiments, the method further includes: in response to an authorization operation of the user, obtaining the account information of the resource transfer account from the resource transfer server.

In some embodiments, the resource includes money, and the resource transfer includes remittance; the resource transfer server includes a remittance server; the resource transfer information includes remittance information; and the resource transfer identifier includes a payment order ID corresponding to the remittance information.

In some embodiments, the remittance server is a server of a third-party payment institution; the resource transfer information includes information of a third-party payment account established by the user at the server of the third-party payment institution, and information of a payment account of a fourth financial institution associated with the third-party payment account.

The resource transfer server completing resource transfer processing based on the resource transfer information corresponding to the resource transfer identifier includes: server of the third-party payment institution initiating a payment notification to a server of the fourth financial institution based on the payment order ID, causing the server of the fourth financial institution to complete remittance payment from the payment account of the fourth financial institution.

The embodiments of the present specification also provide one or more non-transitory computer-readable media. The one or more non-transitory computer-readable media are configured with instructions executable by one or more processors of a user terminal to cause the one or more processors to perform operations including: in response to a resource transfer operation initiated by a user on a transaction client of the user terminal to transfer a resource, generating a resource transfer request, wherein the resource transfer request includes resource transfer information that includes an certificate identifier; sending, through a transaction server corresponding to the transaction client, the resource transfer request to a resource transfer server coupled with the transaction server, causing the resource transfer server to: obtain a resource transfer certificate from a blockchain according to the certificate identifier, wherein the resource transfer server is a node device of the blockchain; perform authenticity verification on the resource transfer certificate; in response to successful authenticity verification on the resource transfer certificate; generate a resource transfer identifier for the resource transfer information; and return the resource transfer identifier to the transaction client through the transaction server; and based on the resource transfer identifier, initiating a resource transfer confirmation to the resource transfer server, causing the resource transfer server to complete resource transfer processing based on the resource transfer information corresponding to the resource transfer identifier.

The embodiments of the present specification also provide a user terminal. The user terminal includes one or more processors and a memory communicatively connected with the one or more processors. The memory is configured to store instructions executable by the one or more processors to cause the one or more processors to perform operations including: in response to a resource transfer operation initiated by a user on a transaction client of the user terminal to transfer a resource, generating a resource transfer request, wherein the resource transfer request includes resource transfer information that includes an certificate identifier; sending, through a transaction server corresponding to the transaction client, the resource transfer request to a resource transfer server coupled with the transaction server, causing the resource transfer server to: obtain a resource transfer certificate from a blockchain according to the certificate identifier, wherein the resource transfer server is a node device of the blockchain; perform authenticity verification on the resource transfer certificate; in response to successful authenticity verification on the resource transfer certificate; generate a resource transfer identifier for the resource transfer information; and return the resource transfer identifier to the transaction client through the transaction server; and based on the resource transfer identifier, initiating a resource transfer confirmation to the resource transfer server, causing the resource transfer server to complete resource transfer processing based on the resource transfer information corresponding to the resource transfer identifier.

Correspondingly, the embodiments of the present specification also provide a resource transfer method applicable to a resource transfer server. The method includes: receiving, through a transaction server corresponding to a user's transaction client, a resource transfer request sent by the user's transaction client, wherein the resource transfer request is generated by the transaction client in response to a resource transfer operation initiated by the user on the transaction client, and the resource transfer request includes resource transfer information; generating a resource transfer identifier for the resource transfer information, and returning the resource transfer identifier to the transaction client through the transaction server; and in response to a resource transfer confirmation sent by the transaction client through the transaction server, completing resource transfer processing based on the resource transfer information corresponding to the resource transfer identifier.

In some embodiments, the resource transfer information includes: a quantity of resources to be transferred, account information of a resource transfer account established by the user on the resource transfer server, and account information of a recipient account of the resource transfer.

In some embodiments, the resource transfer information further includes certification information related to the resource transfer.

The generating a resource transfer identifier for the resource transfer information includes: performing authenticity verification on the resource transfer request based on the certification information; and after the authenticity verification is successful, generating a resource transfer identifier corresponding to the resource transfer information.

In some embodiments, the resource transfer server includes a node device of a blockchain, the certification information includes a certificate identifier of original information of the resource transfer certificate stored on the blockchain. The performing authenticity verification on the resource transfer request based on the certification information includes: obtaining the original information of the resource transfer certificate from the blockchain based on the certificate identifier, and performing authenticity verification based on the original information of the resource transfer certificate.

In some embodiments, the method further includes: in response to an authorization operation of the user, sending the account information of the resource transfer account saved by the user on the resource transfer server to the transaction client through the transaction server.

In some embodiments, the resource includes money, and the resource transfer includes remittance; the resource transfer server includes a remittance server; the resource transfer information is remittance information; and the resource transfer identifier includes a payment order ID corresponding to the remittance information.

In some embodiments, the remittance server is a third-party payment institution server; the resource transfer information includes information of a third-party payment account established by the user at the third-party payment institution financial institution, and information of a payment account of a fourth financial institution associated with the third-party payment account. In response to a resource transfer confirmation sent by the transaction client through the transaction server, completing resource transfer processing based on the resource transfer information corresponding to the resource transfer identifier includes: in response to a payment confirmation sent by the transaction client through the transaction server, initiating a payment notification to a server of the fourth financial institution based on the payment order ID, causing the server of the fourth financial institution to complete remittance payment from the payment account of the fourth financial institution.

Correspondingly, the present specification also provides a resource transfer apparatus applicable to a user's transaction client. The apparatus includes: a generating unit, a sending unit, and a confirming unit.

The generating unit is configured to, in response to a resource transfer operation initiated by the user on the transaction client, generate a resource transfer request, wherein the resource transfer request includes resource transfer information.

The sending unit is configured to send, through a transaction server corresponding to the transaction client, the resource transfer request to the resource transfer server coupled with the transaction server, causing the resource transfer server to generate a resource transfer identifier for the resource transfer information, and return the resource transfer identifier to the transaction client through the transaction server.

The confirming unit is configured to, based on the resource transfer identifier, initiate a resource transfer confirmation to the resource transfer server, causing the resource transfer server to complete resource transfer processing based on the resource transfer information corresponding to the resource transfer identifier.

In some embodiments, the apparatus further includes: an obtaining unit configured to, in response to an authorization operation of the user, obtain the account information of the resource transfer account authorized by the user from the resource transfer server.

Correspondingly, the present specification also provides a resource transfer apparatus applicable to a resource transfer server. The apparatus includes: a receiving unit, a generating unit, a sending unit, and a transferring unit.

The receiving unit is configured to receive, through a transaction server corresponding to a user's transaction client, a resource transfer request sent by the user's transaction client, wherein the resource transfer request is generated by the transaction client in response to a resource transfer operation initiated by the user on the transaction client, and the resource transfer request includes resource transfer information.

The generating unit is configured to generate a resource transfer identifier for the resource transfer information.

The sending unit is configured to return the resource transfer identifier to the transaction client through the transaction server.

The transferring unit is configured to, in response to a resource transfer confirmation sent by the transaction client through the transaction server, complete resource transfer processing based on the resource transfer information corresponding to the resource transfer identifier.

The present specification also provides a computer device including: a memory and a processor, wherein the memory stores a computer program that is executable by the processor; and when executing the computer program, the processor executes the resource transfer method.

The present specification also provides a computer device, including: a memory and a processor, wherein the memory stores a computer program that is executable by the processor; and when executing the computer program, the processor executes the resource transfer method.

Based on the methods, apparatuses, and computer devices for resource transfer provided by the above embodiments of the present specification, a user is benefitted by a resource transfer operation performed on a transaction client that can carry out information exchange operations with a resource transfer server through a transaction server in the process of resource transfer processing, which provides the resource transfer operation that cannot be realized by the existing technology.

### BRIEF DESCRIPTION OF THE DRAWINGS

FIG. 1 is a schematic diagram of a system including a transaction client, a transaction server, and a resource transfer server provided by an exemplary embodiment.

FIG. 2 is a schematic flow chart of a resource transfer method provided by an exemplary embodiment.

FIG. 3 is a schematic flow chart of a remittance method provided by an exemplary embodiment.

FIG. 4 is a method for a transaction client to obtain account information of a user's payment account from a remittance server according to an exemplary embodiment.

FIG. 5 is a schematic diagram of a resource transfer apparatus applicable to a transaction client according to an exemplary embodiment.

FIG. 6 is a schematic diagram of a resource transfer apparatus applicable to a resource transfer server according to an exemplary embodiment.

FIG. 7 is a hardware structure diagram for executing an embodiment of a resource transfer apparatus provided in the present specification.

### DETAILED DESCRIPTION

Here, exemplary embodiments will be described in detail, and their examples are shown in the accompanying drawings. When the following description refers to the drawings, unless otherwise indicated, the same numbers in different drawings indicate the same or similar elements. The embodiments described in the following exemplary embodiments do not represent all the embodiments consistent with one or more embodiments of the present specification. Rather, they are merely examples of apparatuses and methods consistent with some aspects of one or more embodiments of the present specification as detailed in the appended claims.

It should be noted that, in other embodiments, steps of corresponding methods are not necessarily executed in the order shown and described in the present specification. In some other embodiments, the method may include more or fewer steps than what is described in the present specification. In addition, a single step described in the present specification may be divided into multiple steps for description in other embodiments, while multiple steps described in the present specification may also be combined into a single step in other embodiments for description.

Resource allocation is a common concept in the field of computer technology. It can refer to either resource allocation within one device or resource transfers among multiple devices. When a user performs transaction processing based on a computer device, transaction processing-related resource transfer requirements are often involved. Currently, resource transfers among multiple devices can be performed through an application dedicated to resource transfer installed in the electronic devices.

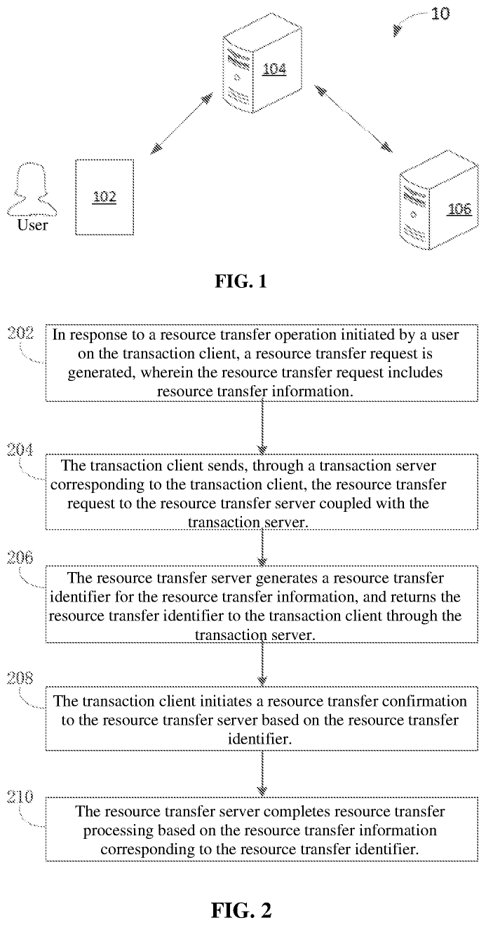

In view of this, one or more embodiments of the present specification provide a resource transfer method, which is applicable to a resource transfer system 10 including a transaction client 102, a transaction server 104, and a resource transfer server 106 shown in FIG. 1. The transaction client 102 and transaction server 104 described in one or more embodiments of the present specification can provide a user with particular transaction services, and the transaction services provided by the transaction client 102 and transaction server 104 facilitate resource transfer with respect to an operator of the transaction server or other users or institutions. In some embodiments, the transaction client 102 may be a software module executable by a processor of a user terminal to perform resource transfer techniques as disclosed herein. For example, in addition to displaying to a user with a list of travel products or overseas study products, a transaction server that provides travel or overseas study services and its corresponding transaction client can also provide a function of performing resource transfer to a merchant corresponding to a product based on the travel products or overseas study products.

This embodiment does not limit forms of the above resources. For example, the above resources may include various forms such as money, securities, shares, physical personal property or real property, and virtual digital assets. When the resources are money, the resource transfer can be embodied as “remittance,” that is, the circulation of monetary funds between user accounts provided by the same or different financial institutions. The circulation of monetary funds can be performed in the same currency, or can also be performed in different currencies. For example, a circulation of monetary funds in different currencies can be performed at a set exchange rate. The circulation of monetary funds may also involve handling fees charged by financial institutions.

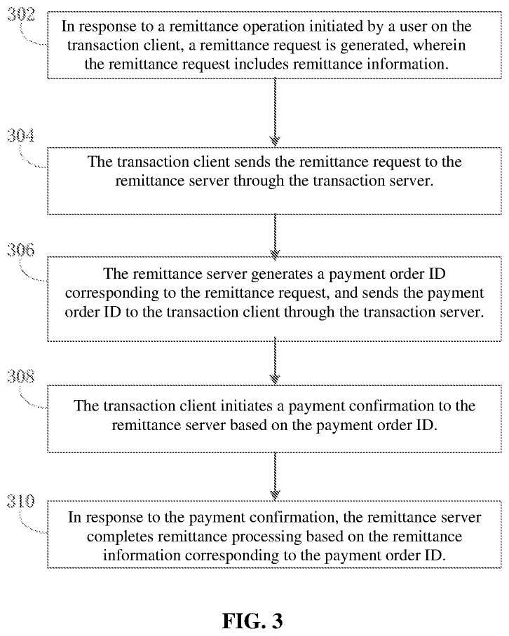

As shown in FIG. 2, the above resource transfer method includes the following operations.

At Step 202, in response to a resource transfer operation initiated by a user on the transaction client of a user terminal to transfer a resource, a resource transfer request is generated, wherein the resource transfer request includes resource transfer information.

In some embodiments, the resource transfer information may include: information about a quantity of resources to be transferred, account information of a resource transfer account established by the user on the resource transfer server, and account information of a recipient account of the resource transfer. In some embodiments, the above resource transfer information can omit the account information of the resource transfer account established by the user on the resource transfer server, and the resource transfer server can determine the account information of the resource transfer account by itself based on the user's identity information.

At Step 204, the resource transfer request is sent, through the transaction server corresponding to the transaction client, to the resource transfer server coupled with the transaction server.

The transaction client and the resource transfer server usually do not have a direct communication connection. The transaction server is configured to forward information for the transaction client and the resource transfer server.

At Step 206, the resource transfer server generates a resource transfer identifier for the resource transfer information, and returns the resource transfer identifier to the transaction client through the transaction server.

At Step 208, the transaction client initiates a resource transfer confirmation to the resource transfer server based on the resource transfer identifier.

The resource transfer confirmation usually includes verification information of the user's identity. The verification information may include one or more pieces of verification information, a device verification code associated with the user's resource transfer account, the user's resource transfer password, the user's biometric information, etc., to prove the user's confirmation for the resource transfer.

At Step 210, the resource transfer server completes resource transfer processing based on the resource transfer information corresponding to the resource transfer identifier.

The resource transfer processing may include: transferring resources corresponding to the quantity of resources to be transferred from the user's resource transfer account to the recipient account.

The resource transfer method described in Steps 202 to 210 facilitates the user to directly initiate and quickly complete a resource transfer operation based on the transaction client, which improves the efficiency of resource transfer.

When money is an exemplary form of the resource, the resource transfer can be embodied as money transfer payment activities such as transfer and remittance. When a user makes a remittance transfer to another user or institution, a user account opened with a bank or other financial institutions or a user account opened with a third-party payment institution associated with a bank is often used for remittance transfer between accounts. For example, the remittance transfer is generally completed through an App provided by bank institutions or third-party payment institutions, or completed at a counter of a bank institution. At present, remittance transfers cannot be performed directly based on user accounts opened by users in a financial institution or a third-party payment institution associated with the financial institution in a transaction application client. When performing a remittance operation, a remitting user often needs to provide financial account information, remittance currency type, remittance amount of the remitting, and receiving users. In some remittance operations, the remitting user may also need to provide information such as the purpose of the remittance, so as to meet the requirements of financial supervision.

In some embodiments, the resource transfer method is applicable to a remittance system including a user's transaction client, a transaction server, and a remittance server. The user establishes a payment account for remittance on the remittance server. The remittance server may include a financial institution server or a third-party payment institution server, and the payment account may include a savings account or a credit account that is created by the user on the remittance server and can be used for remittances. When the remittance server is a third-party payment institution server, the payment account may also include a financial institution account associated with the user's third-party payment account.

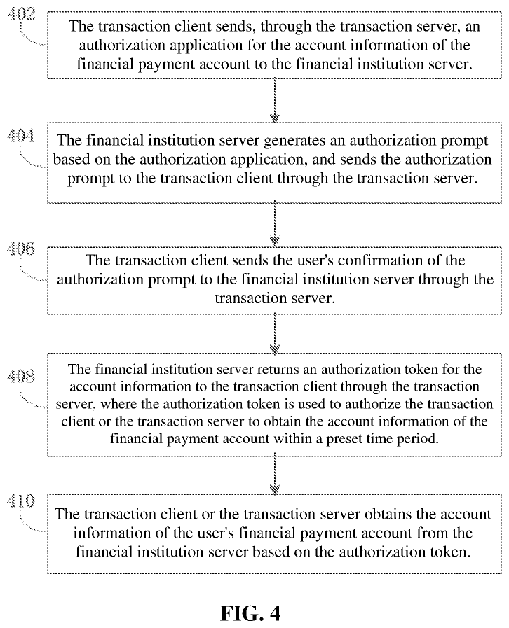

FIG. 3 illustrates a remittance method provided by an exemplary embodiment of the present specification, which may, for example, include the following steps.

At Step 302, in response to a remittance operation initiated by a user on the transaction client, a remittance request is generated, wherein the remittance request includes remittance information.

The remittance information may include a remittance amount, information of a payment account of a remitting user established on a remittance server, and account information of a remittance receiving user. Since the remittance operation based on transaction requirements is directly established on the transaction client, the account information of the remittance receiving user can usually be obtained directly from the transaction server, for example, including the name or account number of the remittance recipient.

The remitting user may be a logged-in user of the transaction client, or may be another user who can pay the remittance amount. The payment account information of the remitting user established on the remittance server can be manually input by the user on a human-computer interaction interface of the transaction client by, for example, inputting the name and account number of the remitting user. It can also be based on the user's authorization to the remittance server to receive, by the transaction client through the transaction server, the account information of its payment account from the remittance server.

The remittance server can be provided with an authorization service module, and the authorization service module is responsible for obtaining, with authorization, the user's payment account information. A method for the transaction client to obtain the account information of the payment account established by the user on the remittance server is shown in FIG. 4, which may include the following operations.

At Step 402, the transaction client sends an authorization application for the account information of the payment account to the remittance server through the transaction server.

At Step 404, the remittance server generates an authorization prompt based on the authorization application, and sends the authorization prompt to the transaction client through the transaction server.

Since the authorization application for the account information of the user's payment account in the financial institution may be an unauthorized activity of the transaction client, in order to further ensure the legitimacy of the authorization to obtain the account information, the authorization service module can generate and return an authorization prompt, causing the transaction client to display the authorization prompt to a user interface. In one example, the authorization prompt may be expressed as an authorization prompt message or an authorization prompt page, and the authorization prompt message or authorization prompt page may include the content of the account information to be obtained by the authorized transaction client, so that the user can indicate an approval or rejection of this account information authorization based on the interaction with the transaction client.

At Step 406, the transaction client sends the user's confirmation of the authorization prompt to the remittance server through the transaction server.

At Step 408, the remittance server returns an authorization token for the account information to the transaction client through the transaction server, where the authorization token is used to authorize the transaction client or the transaction server to obtain the account information of the payment account within a preset time period.

At Step 410, the transaction client or the transaction server receives the account information of the user's payment account from the remittance server based on the authorization token. That is, the remittance server sends the account information of the user's payment account to the transaction server or the transaction client based on the authorization token sent by the transaction client or the transaction server.

Through the process of obtaining the authorization of the account information described in steps 402 to 410, the transaction client can obtain the account information of the payment account from the remittance server, while the user does not need to manually input the user's payment account information to the transaction client, nor does the user need to log in to the payment account on the remittance server to perform an authorization operation, which facilitates automatic information acquisition. Moreover, the content of the account information obtained by the client from the remittance server is authorized and confirmed by the user, and the transaction client or the transaction server can only obtain, based on the above authorization token, the type and content of the account information as confirmed by the user according to the authorization prompt, but cannot obtain other unauthorized account information in the user's payment account, which effectively protects the security of user information.

In some embodiments, the remittance information also includes certification information used to prove the authenticity of the transaction background of this remittance. For example, when a transaction server is used to provide a user with overseas study services, a remittance request sent by a transaction client may include the institution identity information of a school for overseas study, an amount of fees, and purpose certification information to prove that the remittance performed by the user is used for the fees charged by the school. When the transaction server is used to provide a user with guided foreign travel services, a remittance request sent by the transaction client may include the business qualification certification information of a guided travel service agency and charging details to prove that the remittance performed by the user is used for the guided travel service of the service agency, and so on. Those skilled in the art can set up detailed certification information according to actual transaction situations to prove the authenticity of the transaction background of this remittance.

In some embodiments, according to the remittance rules of the remittance server and the attributes of the receiving user's account, the remittance request may also include information such as remittance fees and exchange rates.

At Step 304, the transaction client sends the remittance request to the remittance server through the transaction server.

At Step 306, the remittance server generates a payment order ID corresponding to the remittance request, and sends the payment order ID to the transaction client through the transaction server.

In some embodiments, the process of generating the payment order ID corresponding to the remittance request by the remittance server includes: performing authenticity verification on the remittance request based on the certification information included in the remittance request; and in response to successful authenticity verification on the certification information, generating a payment order ID corresponding to the remittance request.

In some embodiments, in order to further ensure the credibility of the certification information, a blockchain can be used to store original information that can prove the authenticity of the transaction background of this remittance, and the certification information contained in the remittance request includes the certificate identifier of the original information stored on the blockchain, such as a hash digest of the original information, or TXID of the stored transaction, or an address and query interface of a smart contract used to store the original information. The remittance server may include a node device of the blockchain, so as to obtain, based on the certificate identifier, the original information that can prove the authenticity of the transaction background of this remittance from the blockchain, and to perform authenticity verification based on the original information.

The anti-tampering mechanism based on the blockchain can provide technical evidence for the original information that is difficult to tamper with, thereby effectively reducing the security risk of user remittances caused by a transaction server obtaining false or incorrect transaction background authenticity certification information.

In some embodiments, in order to perform authenticity verification on the certification information more quickly and accurately, a smart contract for transaction background information management can be deployed on the blockchain to store the original information that proves the authenticity of the transaction background of this remittance, and authenticity verification is performed on the remittance request based on a preset verification logic and based on the original information.

In one example, the performing authenticity verification on the remittance request based on the certification information included in the remittance request may include: in response to the remittance request sent to the blockchain, invoking the smart contract to execute a logic of performing authenticity verification on the remittance request declared by the smart contract, and to perform authenticity verification on the remittance request based on the original information corresponding to the certificate identifier.

The remittance request may be directly sent to the blockchain by the transaction client or the transaction server, or may be sent to the blockchain by the remittance server, which is not limited in this embodiment.

When the remittance request is sent by the remittance server to the blockchain, the smart contract can also be deployed with a generation logic for payment order IDs. After the remittance request passes the authenticity verification (i.e., the authenticity of the remittance request is verified), a payment order ID corresponding to the remittance request is generated.

At Step 308, the transaction client initiates a payment confirmation to the remittance server based on the payment order ID.

The remittance confirmation information may include one or more of verification information, such as identity verification information of the remitting user, a device verification code associated with the payment account of the remitting user, the user's payment account password, and the user's biometric information, to prove the user confirmation of the remittance payment.

At Step 310, in response to the payment confirmation, the remittance server completes remittance processing based on the remittance information corresponding to the payment order ID.

The remittance server can deduct the remittance amount included in the remittance application/request and a remittance processing fee (if any) from the user's payment account, and then send a remittance notification to the server of the financial institution where the remittance receiving user's account is located, causing the remittance amount to be added to the remittance receiving user's account. Since the remittance service institution where the account of the remitting user is located and the financial institution where the account of the receiving user is located may be different financial institutions, the two financial institutions may not have a direct communication connection, and the remittance may be forwarded by multiple financial servers and eventually reach the receiving user's account.

In some embodiments, the remittance server is a third-party payment institution server; the remittance information includes information of a third-party payment account established by the remitting user at the third-party payment institution financial institution, and information of a payment account of a fourth financial institution associated with the third-party payment account.

The operation of the remittance server completing, in response to the payment confirmation, the remittance processing based on the remittance information corresponding to the payment order ID includes: the third-party payment institution server initiating a payment notification to a server of the fourth financial institution based on the payment order ID, causing the server of the fourth financial institution to complete the remittance payment from the payment account of the fourth financial institution.

In some embodiments, one or more of the transaction server, the third-party payment server, or the server of the fourth financial institution may be a cloud server, so as to reduce the service cost of the transaction service provider and improve the performance of the transaction server. When the transaction server, the third-party payment server, and the server of the fourth financial institution are all cloud servers, it is more convenient for the multiple servers to exchange information and improve the execution efficiency of the remittance transaction.

The remittance process including steps 302 to 310 described in the embodiment above facilitates the user to initiate a remittance operation to the remittance receiving user based on the transaction client without using a client APP of a financial institution or going to a counter of the financial institution to perform the remittance operation, which improves the convenience of the remittance operation.

It is worth noting that during the remittance process including steps 302 to 310 described in the embodiment above, the transaction client exchanges information, such as the remittance request, payment order ID, and payment confirmation information, with the remittance server through the transaction server. After the transaction client obtains the authorization token of the remittance server according to the steps 402 to 410, the transaction client can also apply for trusted authentication of the remittance server to establish a direct, trusted interaction channel with the remittance server, which allows the transaction client to directly exchange information, such as the remittance request, payment order ID, and payment confirmation information, with the remittance server, which is not limited in the present specification.

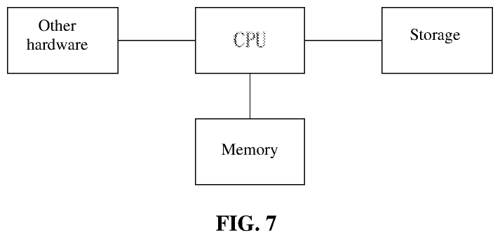

Corresponding to the above-described process implementations, the embodiments of the present specification also provide resource transfer apparatuses 50 and 60. The apparatuses 50 and 60 can be implemented by software, or can be implemented by hardware or a combination of software and hardware. Taking software implementation as an example, as a logical apparatus, it is formed by a Central Processing Unit (CPU) of a device, where the apparatus is located, reading corresponding computer program instructions into a memory for execution. From a hardware perspective, in addition to the CPU, memory, and storage shown in FIG. 7, the device where the apparatus is located usually also includes other hardware such as chips for wireless signal transmission and reception and/or other hardware such as boards for implementing network communication functions.

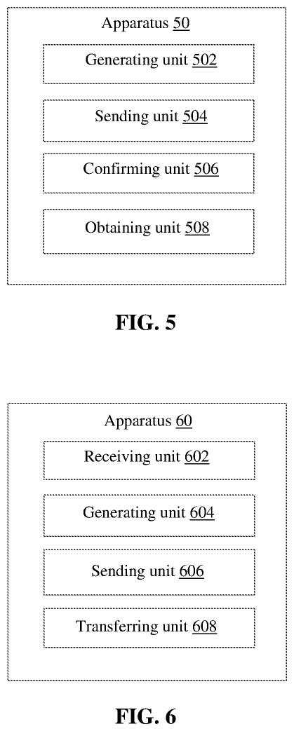

As shown in FIG. 5, the present specification provides a resource transfer apparatus 50 applicable to a user's transaction client. The apparatus 50 includes: a generating unit 502, a sending unit 504, and a confirming unit 506.

The generating unit 502 is configured to, in response to a resource transfer operation initiated by the user on the transaction client of a user terminal to transfer a resource, generate a resource transfer request, wherein the resource transfer request includes resource transfer information.

The sending unit 504 is configured to send, through a transaction server corresponding to the transaction client, the resource transfer request to the resource transfer server coupled with the transaction server, causing the resource transfer server to generate a resource transfer identifier for the resource transfer information, and return the resource transfer identifier to the transaction client through the transaction server.

The confirming unit is 506 configured to, based on the resource transfer identifier, initiate a resource transfer confirmation to the resource transfer server, causing the resource transfer server to complete resource transfer processing based on the resource transfer information corresponding to the resource transfer identifier.

In some embodiments, the resource transfer information includes: a quantity of resources to be transferred, account information of a resource transfer account established by the user on the resource transfer server, and account information of a recipient account for receiving resource transfer.

In some embodiments, the resource transfer information further includes certification information related to the resource transfer.

The resource transfer identifier corresponds to the resource transfer information and is generated after the resource transfer request passes authenticity verification performed by the resource transfer server based on the certification information (i.e., the resource transfer request is authenticated and/or verified by the resource transfer server).

In some embodiments, the apparatus 50 further includes: an obtaining unit 508 configured to, in response to an authorization operation of the user, obtain the account information of the resource transfer account authorized by the user from the resource transfer server.

In some embodiments, the resource includes money, and the resource transfer includes remittance; the resource transfer server includes a remittance server; the resource transfer information includes remittance information; and the resource transfer identifier includes a payment order ID corresponding to the remittance information.

Details of an implementation process of the functions and roles of various units in the apparatus 50 may be referred to the corresponding steps in the resource transfer method executed by the transaction client as described above, which will not be elaborated here.

As shown in FIG. 6, the present specification further provides a resource transfer apparatus 60 applicable to a resource transfer server. The apparatus 60 includes: a receiving unit 602, a generating unit 604, a sending unit 606, and a transferring unit 608.

The receiving unit 602 is configured to receive, through a transaction server corresponding to a user's transaction client, a resource transfer request sent by the user's transaction client, wherein the resource transfer request is generated by the transaction client in response to a resource transfer operation initiated by the user on the transaction client, and the resource transfer request includes resource transfer information.

The generating unit 604 is configured to generate a resource transfer identifier for the resource transfer information.

The sending unit 606 is configured to return the resource transfer identifier to the transaction client through the transaction server.

The transferring unit 608 is configured to, in response to a resource transfer confirmation sent by the transaction client through the transaction server, complete resource transfer processing based on the resource transfer information corresponding to the resource transfer identifier.

In some embodiments, the resource transfer information includes: a quantity of resources to be transferred, account information of a resource transfer account established by the user on the resource transfer server, and account information of a recipient account for receiving resource transfer.

In some embodiments, the resource transfer information further includes certification information related to the resource transfer.

The generating unit 604 is further configured to: perform authenticity verification on the resource transfer request based on the certification information; and after the authenticity verification is successful, generate a resource transfer identifier corresponding to the resource transfer information.

In some embodiments, the resource transfer server includes a node device of a blockchain, the certification information includes a certificate identifier of the original information of the resource transfer certificate stored on the blockchain.

The performing authenticity verification on the resource transfer request based on the certification information includes: obtaining the original information of the resource transfer certificate from the blockchain based on the certificate identifier, and performing authenticity verification based on the original information of the resource transfer certificate.

In some embodiments, the sending unit 608 is further configured to, in response to an authorization operation of the user, send the account information of the resource transfer account saved by the user on the resource transfer server to the transaction client through the transaction server.

In some embodiments, the resource includes money, and the resource transfer includes remittance; the resource transfer server includes a remittance server; the resource transfer information is remittance information; and the resource transfer identifier includes a payment order ID corresponding to the remittance information.

Details of an implementation process of the functions and roles of various units in the apparatus 60 can be referred to the corresponding steps in the resource transfer method executed by the remittance server as described above, which will not be elaborated here.

The apparatus embodiments described above are merely illustrative, where the units described as separate components may or may not be physically separate, and the components displayed as units may or may not be physical modules, that is, they may be located in one place or may be distributed to a plurality of network modules. Some or all of the units or modules can be selected according to actual needs to achieve the objectives of the solution in the present specification. Those of ordinary skill in the art can understand and implement without creative effort.

The apparatuses, units, and modules described in the embodiments above may be implemented, for example, by a computer chip or entity, or implemented by a product having a certain function. A typical implementation device is a computer. In one example, the computer may be, for example, a personal computer, a laptop computer, a cellular phone, a camera phone, a smart phone, a personal digital assistant, a media player, a navigation device, an email receiving and sending device, a game console, a tablet computer, a wearable device, or a combination of any of these devices.

Corresponding to the method embodiments above, the embodiments of the present specification also provide a computer device. As shown in FIG. 7, the computer device includes a memory and a processor. Here, the memory stores a computer program that is executable by the processor. When the processor executes the stored computer program, various steps of the resource transfer method executed by the transaction client in the embodiments of the present specification are executed.

Corresponding to the method embodiments above, the embodiments of the present specification also provide a computer device. As shown in FIG. 7, the computer device includes a memory and a processor. Here, the memory stores a computer program that is executable by the processor. When the processor executes the stored computer program, various steps of the resource transfer method executed by the remittance server in the embodiments of the present specification are executed.

The above-described is only preferred embodiments of the present specification, which are not used to limit the present specification. Any modification, equivalent substitution, or improvement made within the spirit and principle of the present specification shall be encompassed in the protection scope of the present specification.

In a typical configuration, a computing device includes one or more processors (CPUs), input/output interfaces, network interfaces, and a memory.

The memory may include non-permanent memory in a computer-readable medium, random access memory (RAM) and/or non-volatile memory, such as read-only memory (ROM) or flash memory (flash RAM). The memory is an example of a computer readable medium.

Computer readable media include permanent, non-permanent, mobile, and immobile media, which can implement information storage through any method or technology. The information can be computer-readable instructions, data structures, program modules, or other data.

Examples of storage media of computers include, but are not limited to, Phase-change Random Access Memories (PRAMs), Static Random Access Memories (SRAMs), Dynamic Random Access Memories (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, magnetic cassettes, cassette and disk memories or other magnetic memory devices, or any other non-transmission media, which can be used for storing information accessible to a computation device. According to the definitions in the present specification, the computer-readable media do not include transitory media, such as modulated data signals and carriers.

It should also be noted that the terms “include,” “comprise,” or any other variants thereof are intended to encompass a non-exclusive inclusion, allowing a process, method, product, or device including a series of elements to not only include these elements, but also include other elements that are not clearly listed, or further include elements that are inherent to the process, method, product, or device. When there is no further restriction, elements defined by the statement “including one . . . ” do not exclude that a process, method, product, or device including the elements further includes additional identical elements.

Those skilled in the art should understand that the implementation of the present specification can be provided as a method, a system, or a computer program product. Therefore, the implementation manners in the present specification may adopt the form of a complete hardware embodiment, a complete software embodiment, or an embodiment combining software and hardware aspects. Moreover, the embodiments of the present specification may be in the form of a computer program product implemented on one or more computer usable storage media (including, but not limited to, a magnetic disk memory, CD-ROM, an optical memory, etc.) including computer usable program code.

1. A resource transfer method comprising:
in response to a resource transfer operation initiated by a user on a transaction client of a user terminal to transfer a resource, generating, by the user terminal, a resource transfer request, wherein the resource transfer request includes resource transfer information that includes an certificate identifier;
sending, by the user terminal through a transaction server corresponding to the transaction client, the resource transfer request to a resource transfer server coupled with the transaction server, causing the resource transfer server to:
obtain a resource transfer certificate from a blockchain according to the certificate identifier, wherein the resource transfer server is a node device of the blockchain;
perform authenticity verification on the resource transfer certificate;
in response to successful authenticity verification on the resource transfer certificate; generate a resource transfer identifier for the resource transfer information; and
return the resource transfer identifier to the transaction client through the transaction server; and
based on the resource transfer identifier, initiating, by the user terminal, a resource transfer confirmation to the resource transfer server, causing the resource transfer server to complete resource transfer processing based on the resource transfer information corresponding to the resource transfer identifier.

2. The method according to claim 1, wherein the resource transfer information includes: a quantity of resources to be transferred, account information of a resource transfer account established by the user on the resource transfer server, and account information of a recipient account for receiving resource transfer.

3. The method according to claim 2, wherein the resource transfer information further includes certification information related to the resource transfer from the resource transfer account to the recipient account, and
the resource transfer identifier corresponds to the resource transfer information and is generated after the resource transfer request is authenticated by the resource transfer server based on the certification information.

4. The method according to claim 2, further comprising:
in response to an authorization operation of the user, obtaining the account information of the resource transfer account from the resource transfer server.

5. The method according to claim 1, wherein the resource includes money, and the resource transfer processing includes remittance; the resource transfer server includes a remittance server; the resource transfer information includes remittance information; and the resource transfer identifier includes a payment order ID corresponding to the remittance information.

6. The method according to claim 5, wherein
the remittance server is a server of a third-party payment institution;
the resource transfer information includes information of a third-party payment account established by the user at the server of the third-party payment institution and information of a payment account of a fourth financial institution associated with the third-party payment account; and
the resource transfer server completing resource transfer processing based on the resource transfer information corresponding to the resource transfer identifier comprises:
the server of the third-party payment institution initiating a payment notification to a server of the fourth financial institution based on the payment order ID, causing the server of the fourth financial institution to complete remittance payment from the payment account of the fourth financial institution.

7. The method according to claim 2, further comprising:
displaying a message on a user interface of the user terminal to prompt the user to authorize the resource transfer from the resource transfer account to the recipient account.

8. One or more non-transitory computer-readable media configured with instructions executable by one or more processors of a user terminal to cause the one or more processors to perform operations comprising:
in response to a resource transfer operation initiated by a user on a transaction client of the user terminal to transfer a resource, generating a resource transfer request, wherein the resource transfer request includes resource transfer information that includes an certificate identifier;
sending, through a transaction server corresponding to the transaction client, the resource transfer request to a resource transfer server coupled with the transaction server, causing the resource transfer server to:
obtain a resource transfer certificate from a blockchain according to the certificate identifier, wherein the resource transfer server is a node device of the blockchain;
perform authenticity verification on the resource transfer certificate;
in response to successful authenticity verification on the resource transfer certificate; generate a resource transfer identifier for the resource transfer information; and
return the resource transfer identifier to the transaction client through the transaction server; and
based on the resource transfer identifier, initiating a resource transfer confirmation to the resource transfer server, causing the resource transfer server to complete resource transfer processing based on the resource transfer information corresponding to the resource transfer identifier.

9. The one or more non-transitory computer-readable media according to claim 8, wherein the resource transfer information includes: a quantity of resources to be transferred, account information of a resource transfer account established by the user on the resource transfer server, and account information of a recipient account for receiving resource transfer.

10. The one or more non-transitory computer-readable media according to claim 9, wherein the resource transfer information further includes certification information related to the resource transfer from the resource transfer account to the recipient account, and
the resource transfer identifier corresponds to the resource transfer information and is generated after the resource transfer request is authenticated by the resource transfer server based on the certification information.

11. The one or more non-transitory computer-readable media according to claim 9, wherein the operations further comprise:
in response to an authorization operation of the user, obtaining the account information of the resource transfer account from the resource transfer server.

12. The one or more non-transitory computer-readable media according to claim 8, wherein the resource includes money, and the resource transfer processing includes remittance; the resource transfer server includes a remittance server; the resource transfer information includes remittance information; and the resource transfer identifier includes a payment order ID corresponding to the remittance information.

13. The one or more non-transitory computer-readable media according to claim 12, wherein:
the remittance server is a server of a third-party payment institution;
the resource transfer information includes information of a third-party payment account established by the user at the server of the third-party payment institution and information of a payment account of a fourth financial institution associated with the third-party payment account; and
the resource transfer server completing resource transfer processing based on the resource transfer information corresponding to the resource transfer identifier comprises:
the server of the third-party payment institution initiating a payment notification to a server of the fourth financial institution based on the payment order ID, causing the server of the fourth financial institution to complete remittance payment from the payment account of the fourth financial institution.

14. The one or more non-transitory computer-readable media according to claim 9, wherein the operations further comprise:
displaying a message on a user interface of the user terminal to prompt the user to authorize the resource transfer from the resource transfer account to the recipient account.

15. A user terminal comprising:
one or more processors; and
a memory communicatively connected with the one or more processors, wherein the memory is configured to store instructions executable by the one or more processors to cause the one or more processors to perform operations comprising:
in response to a resource transfer operation initiated by a user on a transaction client of the user terminal to transfer a resource, generating a resource transfer request, wherein the resource transfer request includes resource transfer information that includes an certificate identifier;
sending, through a transaction server corresponding to the transaction client, the resource transfer request to a resource transfer server coupled with the transaction server, causing the resource transfer server to:
obtain a resource transfer certificate from a blockchain according to the certificate identifier, wherein the resource transfer server is a node device of the blockchain;
perform authenticity verification on the resource transfer certificate;
in response to successful authenticity verification on the resource transfer certificate; generate a resource transfer identifier for the resource transfer information; and
return the resource transfer identifier to the transaction client through the transaction server; and
based on the resource transfer identifier, initiating a resource transfer confirmation to the resource transfer server, causing the resource transfer server to complete resource transfer processing based on the resource transfer information corresponding to the resource transfer identifier.

16. The user terminal according to claim 15, wherein the resource transfer information includes: a quantity of resources to be transferred, account information of a resource transfer account established by the user on the resource transfer server, and account information of a recipient account for receiving resource transfer.

17. The user terminal according to claim 16, wherein the resource transfer information further includes certification information related to the resource transfer from the resource transfer account to the recipient account, and
the resource transfer identifier corresponds to the resource transfer information and is generated after the resource transfer request is authenticated by the resource transfer server based on the certification information.

18. The user terminal according to claim 16, wherein the operations further comprise:
in response to an authorization operation of the user, obtaining the account information of the resource transfer account from the resource transfer server.

19. The user terminal to claim 15, wherein the resource includes money, and the resource transfer processing includes remittance; the resource transfer server includes a remittance server;
the resource transfer information includes remittance information; and the resource transfer identifier includes a payment order ID corresponding to the remittance information.

20. The user terminal according to claim 19, wherein:
the remittance server is a server of a third-party payment institution;
the resource transfer information includes information of a third-party payment account established by the user at the server of the third-party payment institution and information of a payment account of a fourth financial institution associated with the third-party payment account; and
the resource transfer server completing resource transfer processing based on the resource transfer information corresponding to the resource transfer identifier comprises:
the server of the third-party payment institution initiating a payment notification to a server of the fourth financial institution based on the payment order ID, causing the server of the fourth financial institution to complete remittance payment from the payment account of the fourth financial institution.
